(19) United States
(12) Patent Application Publication
(10) Pub. No.: US 2014/0224966 A1
(43) Pub. Date: Aug. 14, 2014

(54) ANTI-GLARE MIRROR AND METHOD TO VARY REFLECTANCE THEREOF

(71) Applicant: TINTABLE SMART MATERIAL CO., LTD., TAINAN CITY (TW)

(72) Inventor: Yi-Wen CHUNG, Tainan City (TW)

(73) Assignee: TINTABLE SMART MATERIAL CO., LTD., TAINAN CITY (TW)

(21) Appl. No.: 14/168,290

(22) Filed: Jan. 30, 2014

(30) Foreign Application Priority Data
Feb. 8, 2013 (TW) 102109648

(51) Int. Cl. B60R 1/08

(52) U.S. Cl. CPC B60R 1/088
USPC 250/208.4

(57) ABSTRACT

An anti-glare mirror has opposite reflecting and back sides, and includes a plurality of electro-chromic units disposed in a casing, a first light sensor, a plurality of second light sensors, and a processor. The first light sensor is disposed on the casing, and is operable for sensing ambient brightness incident upon the back side. The second light sensors are disposed on the casing at positions corresponding to the electro-chromic units, respectively, and are operable for sensing ambient brightness incident upon the reflecting side. The processor compares the ambient brightness detected by the first light sensor and by the second light sensors, and determines whether to drive the electro-chromic units to vary in reflectance.

### CROSS-REFERENCE TO RELATED APPLICATION

This application claims priority of Taiwanese Application No. 102109648, filed on Feb. 8, 2013.

### BACKGROUND OF THE INVENTION

1. Field of the Invention

The invention relates to an anti-glare mirror, and a method to vary reflectance of the anti-glare mirror.

2. Description of the Related Art

While driving a vehicle, a driver's vision sometimes is interrupted by glare from a rearview mirror, which maybe caused by sunlight or by headlights of a following vehicle at night. Thus, conventional anti-glare mirrors are gradually being adopted for the rearview mirrors or wing mirrors of the vehicle. One method to produce the conventional anti-glare mirrors is to implement a color-variable material that can be electrically-induced, thermally-induced, or photo-induced. The electrically-induced color-variable (i.e., electro-chromic) material is capable of changing in color (e.g., become dimmer) in response to an applied electrical field. Although the conventional anti-glare mirror, which adopts the electro-chromic material, may be relatively dark in color as a whole to diminish the glare caused by the headlights of the following vehicle projecting thereon at night, the dimmed color of the conventional anti-glare mirror may not provide clear vision for the driver to observe surrounding environment, and driving safety may thus be endangered.

### SUMMARY OF THE INVENTION

Therefore, the object of the present invention is to provide an anti-glare mirror that may alleviate the aforementioned drawbacks associated with the prior art.

According to one aspect of the present invention, an anti-glare mirror includes a casing, a plurality of electro-chromic units, a first light sensor, a plurality of second light sensors, and a processor.

The casing defines a receiving space. The electro-chromic units are disposed in the receiving space of the casing.

The first light sensor is disposed on the casing and is operable for sensing ambient brightness incident upon a back side of the anti-glare mirror.

The second light sensors are disposed on the casing at positions corresponding to the electro-chromic units, respectively, and are operable for sensing ambient brightness incident upon a reflecting side of the anti-glare mirror that is opposite to the back side.

The processor is electrically coupled to the first light sensor, the second light sensors and the electro-chromic units, and is operable to compare the ambient brightness detected by the first light sensor with the ambient brightness detected by each of the second light sensors and to determine whether to drive a corresponding one of the electro-chromic units to vary reflectance thereof based on a result of comparison made thereby.

According to another aspect of the present invention, a method for varying reflectance of an anti-glare mirror, which has opposite reflecting and back sides, and includes a casing defining a receiving space, a plurality of electro-chromic units disposed in the receiving space, a first light sensor disposed on the casing at positions corresponding respectively to the electro-chromic units, and a processor electrically coupled to the first light sensor, the second light sensors and the electro-chromic units, includes the following steps of:

(a) sensing, by the first light sensor, ambient brightness incident upon the back side of the anti-glare mirror;

(b) sensing, by the second light sensors, ambient brightness incident upon the reflecting side of the anti-glare mirror; and

(c) comparing, by the processor, the ambient brightness detected by the first light sensor with the ambient brightness detected by each of the second light sensors to determine whether to drive a corresponding one of the electro-chromic units to vary reflectance thereof based on a result of comparison made thereby.

### BRIEF DESCRIPTION OF THE DRAWINGS

Other features and advantages of the present invention will become apparent in the following detailed description of the preferred embodiments with reference to the accompanying drawings, of which:

FIG. 1 is a front view of a first preferred embodiment of an anti-glare mirror used in a vehicle according to the invention;

FIG. 2 is a sectional view of the first preferred embodiment;

FIG. 3 is a block diagram of the first preferred embodiment, illustrating electrical connections among a processor, a first light sensor, second light sensors and electro-chromic units;

FIG. 4 is a schematic diagram of the first preferred embodiment, illustrating that one of the electro-chromic units on a right side of a casing is varied in color from others; and

FIG. 5 is a sectional view of a second preferred embodiment illustrating that electrolyte layers of the electro-chromic units are interconnected.

### DETAILED DESCRIPTION OF THE PREFERRED EMBODIMENTS

Before the present invention is described in greater detail, it should be noted that like elements are denoted by the same reference numerals throughout the disclosure.

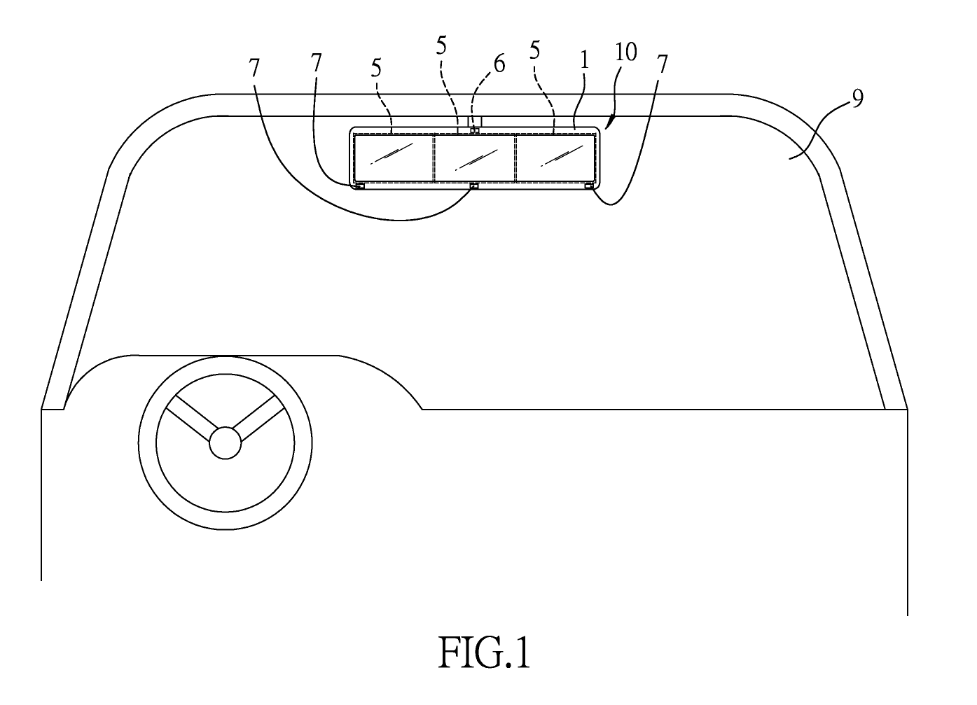

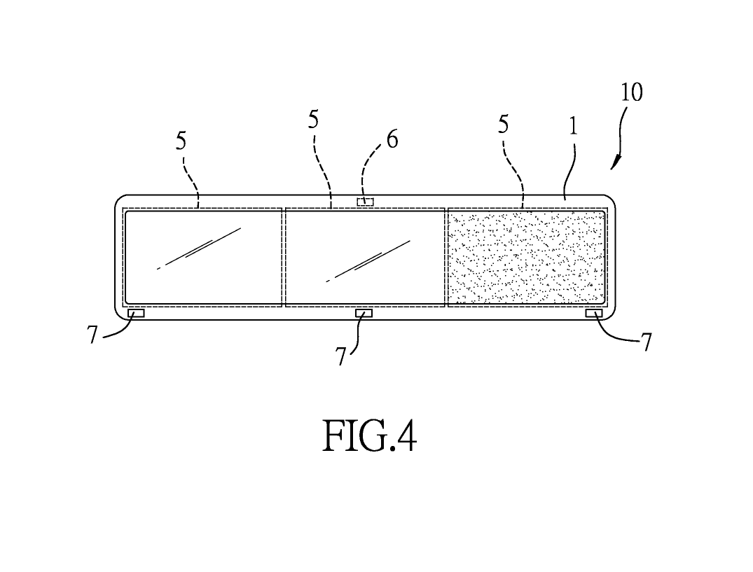

Referring to FIGS. 1 to 4, the first preferred embodiment of an anti-glare mirror 10 according to the present invention is used, for example, in a vehicle 9 (see FIG. 1). Although the vehicle 9 is exemplified as a car in this embodiment, other types of vehicles, such as a truck, an electric car or the like, may suffice and are not limited thereto. Moreover, as shown in FIGS. 1 and 4, although the anti-glare mirror 10 is implemented as a rearview mirror, it can be implemented as a wing mirror or other types of mirrors used in the vehicle 9.

The first preferred embodiment of the anti-glare mirror 10 includes a casing 1, a first substrate 2, a second substrate 3, a metallic reflective layer 4, three electro-chromic units 5, a first light sensor 6, three second light sensors 7, and a processor 8.

The casing 1 defines a receiving space 11 with an opening 12 facing a rear side of the vehicle 9, and has a back wall 13 facing a front side of the vehicle 9.

The first and second substrates 2, 3 are spaced apart from each other, and are disposed in the receiving space 11 of the casing 1. In particular, the first substrate 2 is attached to the back wall 12 of the casing 13, and the second substrate 3 is disposed adjacent to the opening 12. The first substrate 2 has a first surface facing the second substrate 3, and the second substrate 3 has a second surface 31 facing the first substrate 2. In this embodiment, the first and second substrates 2, 3 may be made of glass, plastic, or metallic material. Further, the second substrate 3 is transparent, and the first substrate 2 may be transparent as well.

The metallic reflective layer 4 is disposed on the first surface 21 of the first substrate 2, and may be made of a material of high reflective coefficient, such as aluminum, titanium, chromium, stainless steel, silver, or copper.

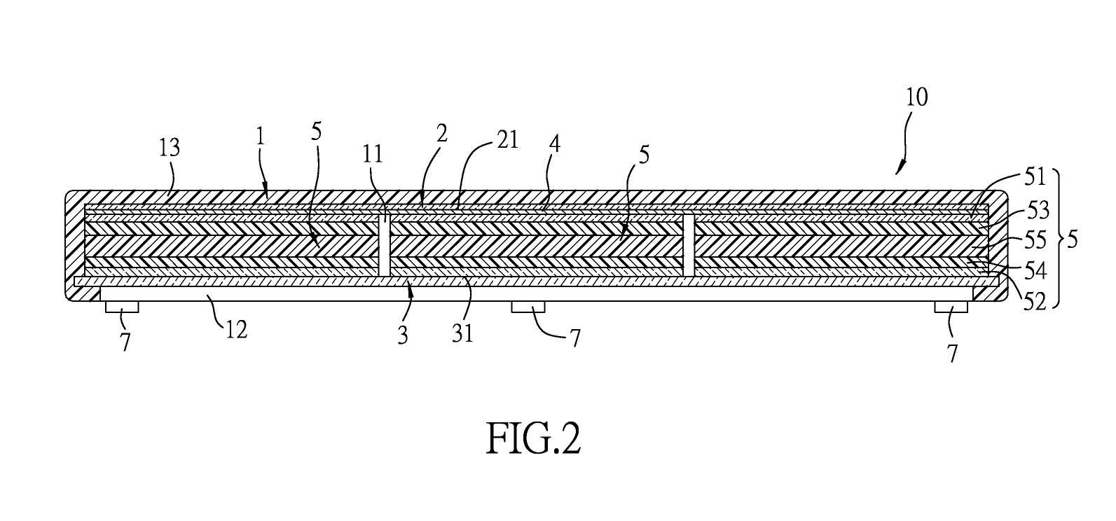

As shown in FIG. 2, the electro-chromic units 5 are disposed in the receiving space 11, and are interposed between the first and second substrates 2, 3. To be specific, the electro-chromic units 5 are sandwiched between the second surface 31 of the second substrate 3 and the metallic reflective layer 4. In this embodiment, the electro-chromic units 5 are spaced apart from one another, and are sequentially arranged in a left-right direction, such that the anti-glare mirror 10 is divided into three reflecting areas corresponding to the electro-chromic units 5, respectively. Each of the electro-chromic units 5 includes a first transparent electrically-conductive layer 51 disposed on the metallic reflective layer 4 opposite to the first substrate 2, a second transparent electrically-conductive layer 52 disposed on the second surface 31 of the second substrate 3, an electrolyte layer 55 disposed between the first and second transparent electrically-conductive layers 51, 52, an electro-chromic layer 53 sandwiched between the electrolyte layer 55 and the first transparent electrically-conductive layer 51, and an ion storing layer 54 sandwiched between the electrolyte layer 55 and the second transparent electrically-conductive layer 52. It should be noted that the number of the electro-chromic units 5 is not limited to three, and other numbers of the electro-chromic units 5 will suffice, such as two or more than three.

The first transparent electrically-conductive layer 51 of each of the electro-chromic units 5 serves as an electrode in this embodiment, and can be made of indium tin oxide (ITO), fluorine-doped tin oxide (FTC)), aluminum zinc oxide (AZO), gallium zinc oxide (GZO), carbon nano-materials, electrically-conductive polymers, metals or the like. The second transparent electrically-conductive layer 52 serves as an electrode as well, and can be made of the same material as that of the first transparent electrically-conductive layer 51.

The electro-chromic layer 53 of each of the electro-chromic units 5 is capable of changing color while being supplied with electricity (e.g., in a reduction state), and returning to its original color when supply of electricity is terminated (e.g., in an oxidation state). The electro-chromic layer 53 of the electro-chromic units 5 can be made of a transition metal oxide, an intercalated compound or an organic compound. The transition metal oxide may be, but is not limited to, tungsten oxide (WO₃), nickel oxide (NiOₓ), vanadium oxide (V₂O₅), or copper oxide (CuOₓ). The intercalated compound may be, but is not limited to, Prussian blue (Fe₄[Fe(CN)₆]₃). The organic compound may be, but not limited to, polyaniline (PANI) or viologen. The ion-storing layer 54 can be made of the same material as that of the electro-chromic layer 53.

In this embodiment, the electrolyte layer 55 of each of the electro-chromic units 5 may be composed of a polymeric material, a metal salt, and an additive. The polymeric material may be, but is not limited to, polymethyl methacrylate (PMMA), polyvinylidene diflouride (PVDF), polyvinyl chloride (PVC), polyethylene oxide (PEO), polyethylene terephthalate (PET), polyhydroxyethyl methacrylate (PHEMA), polyvinyl butyral (PVB), or ethylene vinyl acetate (EVA). The metal salt may be, but is not limited to, lithium salt, acid salt or potassium salt. The additive may include, but is not limited to, carbonate ester. The first light sensor 6 is disposed on the casing 1, and is operable for sensing ambient brightness incident upon a back side of the anti-glare mirror 10, i.e., from a direction where the back wall 13 of the casing 1 faces (as well as the front side of the vehicle 9 faces). In practice, the first light sensor 6 is not limited to a position disclosed in this embodiment, and may be located at any position where the first light sensor 6 can sense the ambient brightness incident upon the back side of the anti-glare mirror 10.

The second light sensors 7 are spaced apart from one another, and are disposed on the casing 1 at positions corresponding respectively to the electro-chromic units 5. Each of the second light sensors 7 is operable for sensing ambient brightness incident upon a reflecting side of the anti-glare mirror 10 opposite to the back side, i.e., from a direction where the opening 12 of the casing 1 faces (as well as the rear side of the vehicle 9 faces). The number of the second light sensors 7 corresponds to the number of the electro-chromic units 5 and is not limited to three.

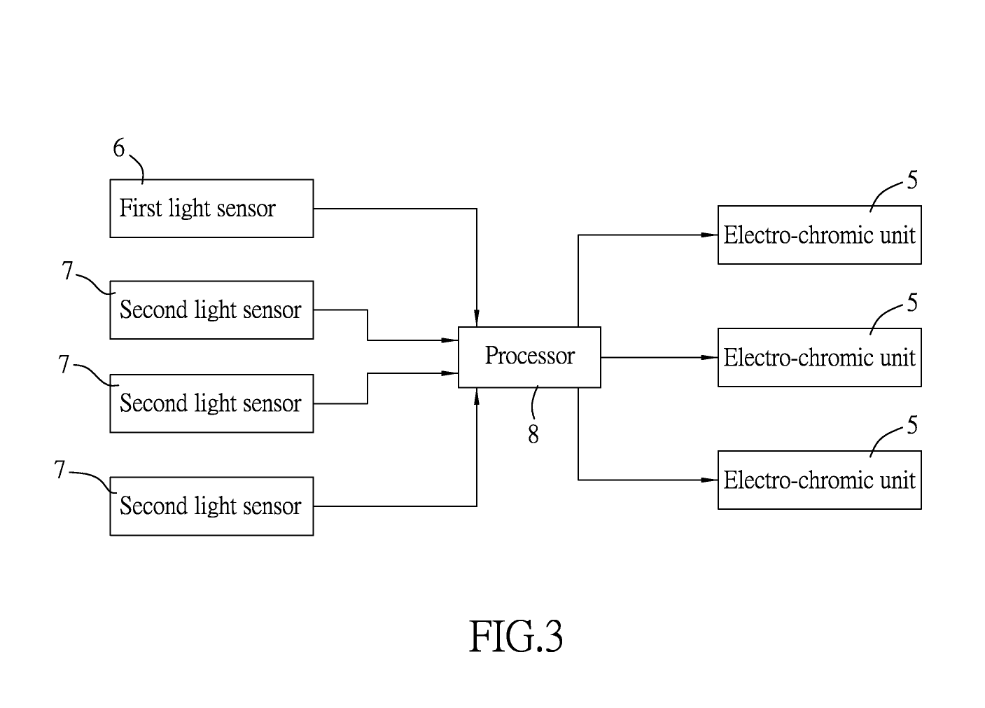

As shown in FIG. 3, the processor 8 is electrically coupled to the first light sensor 6, the second light sensors 7 and the electro-chromic units 5. In this embodiment, an electrical connection between the processor 8 and each of the electro-chromic unit 5 is established by utilizing two conducting wires (not shown), each of which electrically couples the processor 8 to a respective one of the first and second transparent electrically-conductive layers 51, 52 of a corresponding one of the electro-chromic units 5, so as to form a loop.

According to the first preferred embodiment, a method for varying reflectance of the anti-glare mirror 10 includes the following steps of:

(a) sensing, by the first light sensor 6, the ambient brightness incident upon the back side of the anti-glare mirror 10;

(b) sensing, by the second light sensors 7, the ambient brightness incident upon the reflecting side of the anti-glare mirror 10; and

(c) comparing, by the processor 8, the ambient brightness detected by the first light sensor 6 with the ambient brightness detected by each of the second light sensors 7 to determine whether to drive a corresponding one of the electro-chromic units 5 to vary reflectance thereof based on a result of comparison made by the processor 8.

While using the first preferred embodiment of the anti-glare mirror 10 according to the present invention, the first and second light sensors 6, 7 continuously operate to detect the ambient brightness, and the processor 8 operates to compare the ambient brightness detected by the first light sensor 6 with the ambient brightness detected by each of the second light sensors 7 and to determine whether to drive a corresponding one of the electro-chromic units 5 to vary the reflectance thereof (i.e., to change in color) based on the comparison result. In this embodiment, the processor 8 operates to drive one of the electro-chromic units 5 to change in color (e.g. become darker) when the ambient brightness detected by a corresponding one of the second light sensors 7 is greater than that detected by the first light sensor 6 and is greater than a predetermined value.

It should be noted that the ambient brightness at night is usually around 30 nits, and a light source having a brightness level of greater than 100 nits would cause glare to human eyes. Thus, for instance, the predetermined value can be set up at 100 nits or in the range of 100 nits to 200 nits, but the present invention should not be limited thereto.

In one variation of this embodiment, the processor 8 may drive one of the electro-chromic units 5 to change in color when the ambient brightness detected by the corresponding one of the second light sensors 7 is greater than the ambient brightness detected by the first light sensor 6 by a value ranging from 20% to 80% of the ambient brightness detected by the first light sensor 6.

In another variation of this embodiment, the processor 8 may drive one of the electro-chromic units to change in color when the ambient brightness detected by the corresponding one of the second light sensors 7 is greater than the ambient brightness detected by the first light sensor 7 by at least 10 Lux.

It should be noted that when the processor 8 drives any one of the electro-chromic units 5, electrons enter into the first transparent electrically-conductive layer 51 and move toward the electro-chromic layer 53. In the meantime, ions stored in the electrolyte layer (e.g., lithium ions) will also move toward the electro-chromic layer 53 and combine with the electrons at the electro-chromic layer 53, so as to cause the reflectance of the electro-chromic layer 53 to vary via reduction reaction.

As shown in FIGS. 1 and 3 and further referring to FIG. 4, when another vehicle turns on its headlights at night and is approaching from the rear right-hand side of the vehicle 9, the ambient brightness detected by the second light sensor 7, which is located on the right side of the anti-glare mirror 10, should be greater than that detected by the first light sensor 6 and greater than the predetermined value, so that the processor 8 drives the corresponding one of the electro-chromic unit 5 (i.e., the right one) to become darker, so as to diminish glare caused by the headlights of the approaching vehicle. Since the remaining two electro-chromic units 5 may not change in color due to the ambient brightness detected by the corresponding second light sensors 7 being not greater than the ambient brightness detected by the first light sensor 6, the reflecting areas of the anti-glare mirror 10 corresponding to the remaining two electro-chromic units 5 may still allow drivers to observe surrounding environment without causing dimmed vision.

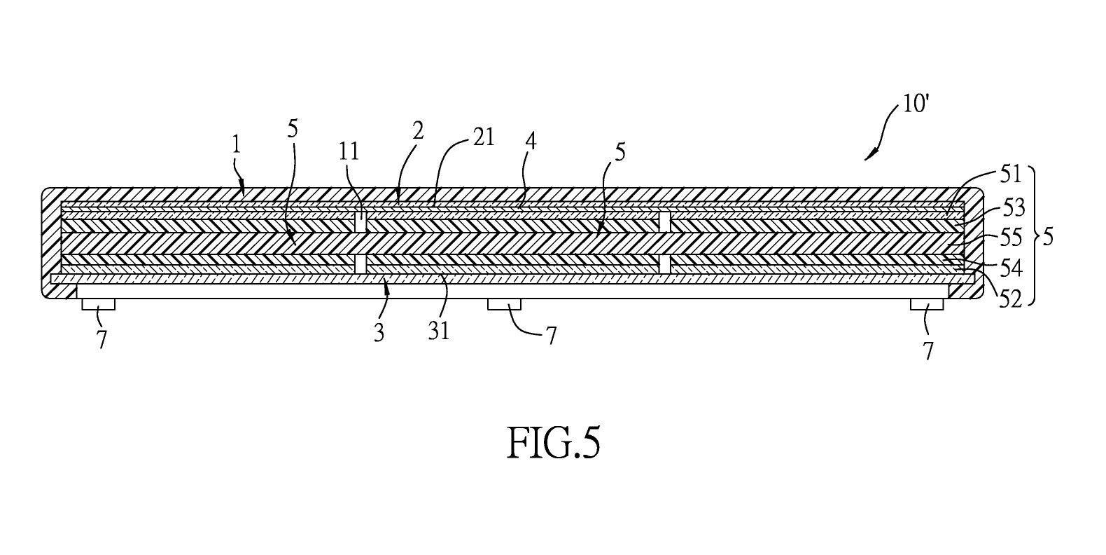

Referring to FIG. 5, the second preferred embodiment of the anti-glare mirror 10′ of this invention is shown to be similar to that of the first preferred embodiment. The difference therebetween resides in the configuration of the electro-chromic units 5. In this embodiment, the electrolyte layers 55 of the electro-chromic units 5 are interconnected. Since ions have much lower mobility than electrons in response to an applied electric field (merely depending on diffusion), it takes much longer for ions in the interconnected electrolyte layer 55 to diffuse toward the electro-chromic layers 53 of other electro-chromic units 5 which are not driven to change in color by the processor 8, thereby assuring the same effect for the anti-glare mirror 10′ of the second preferred embodiment as the first preferred embodiment.

To sum up, the anti-glare mirror 10, 10′ of the present invention is capable of preventing glare by utilizing the processor 8 to determine whether to drive the electro-chromic units 5 to vary in reflectance by comparing the ambient brightness detected by the first light sensor 6 with the ambient brightness detected by the second light sensors 7. Moreover, the configuration of the multiple electro-chromic units 5 can provide the anti-glare mirror 10, 10′ with clear views at least in some areas thereof, and allows the driver to observe surrounding environment without dimmed vision.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An anti-glare mirror comprising:
a casing defining a receiving space;
a plurality of electro-chromic units disposed in said receiving space of said casing;
a first light sensor disposed on said casing and operable for sensing ambient brightness incident upon a back side of said anti-glare mirror;
a plurality of spaced-apart second light sensors disposed on said casing at positions corresponding to said electro-chromic units, respectively, and operable for sensing ambient brightness incident upon a reflecting side of said anti-glare mirror that is opposite to the back side; and
a processor that is electrically coupled to said first light sensor, said second light sensors and said electro-chromic units, and that is operable to compare the ambient brightness detected by said first light sensor with the ambient brightness detected by each of said second light sensors and to determine whether to drive a corresponding one of said electro-chromic units to vary reflectance thereof based on a result of comparison made thereby.

2. The anti-glare mirror as claimed in claim 1, wherein said processor is operable to drive one of said electro-chromic units to vary the reflectance thereof when the ambient brightness detected by a corresponding one of said second light sensors is greater than that detected by said first light sensor and is greater than a predetermined value.

3. The anti-glare mirror as claimed in claim 1, further comprising opposite first and second substrates disposed in said receiving space and receiving said electro-chromic units therebetween.

4. The anti-glare mirror as claimed in claim 3, wherein said first substrate has a first surface facing said second substrate, and said anti-glare mirror further comprises a metallic reflective layer disposed on said first surface of said first substrate.

5. The anti-glare mirror as claimed in claim 4, wherein said second substrate has a second surface facing said first substrate, and each of said electro-chromic units includes a first transparent electrically-conductive layer disposed on said metallic reflective layer opposite to said first substrate, a second transparent electrically-conductive layer disposed on said second surface of said second substrate, an electrolyte layer disposed between said first and second transparent electrically-conductive layers, an electro-chromic layer sandwiched between said first transparent electrically-conductive layer and said electrolyte layer, and an ion storing layer sandwiched between said second transparent electrically-conductive layer and said electrolyte layer.

6. The anti-glare mirror as claimed in claim 5, wherein said electrolyte layers of said electro-chromic units are interconnected.

7. A method for varying reflectance of an anti-glare mirror, which has opposite reflecting and back sides, and includes a casing defining a receiving space, a plurality of electro-chromic units disposed in the receiving space, a first light sensor disposed on the casing, a plurality of spaced-apart second light sensors disposed on the casing at positions corresponding respectively to the electro-chromic units, and a processor electrically coupled to the first light sensor, the second light sensors and the electro-chromic units, said method comprising the following steps of:
(a) sensing, by the first light sensor, ambient brightness incident upon the back side of the anti-glare mirror;
(b) sensing, by the second light sensors, ambient brightness incident upon the reflecting side of the anti-glare mirror; and
(c) comparing, by the processor, the ambient brightness detected by the first light sensor with the ambient brightness detected by each of the second light sensors to determine whether to drive a corresponding one of the electro-chromic units to vary reflectance thereof based on a result of comparison made thereby.

8. The method as claimed in claim 7, wherein, in step (c), the processor drives one of the electro-chromic units to vary the reflectance thereof when the ambient brightness detected by a corresponding one of the second light sensors is greater than that detected by the first light sensor and is greater than a predetermined value.

9. The method as claimed in claim 7, wherein, in step (c), the processor drives one of the electro-chromic units to vary the reflectance thereof when the ambient brightness detected by a respective one of the second light sensors is greater than the ambient brightness detected by the first light sensor by a value ranging from 20% to 80% of the ambient brightness detected by the first light sensor.

10. The method as claimed in claim 7, wherein, in step (c), the processor drives one of the electro-chromic units to vary the reflectance thereof when the ambient brightness detected by a respective one of the second light sensors is greater than the ambient brightness detected by the first light sensor by at least 10 Lux.
